(19) United States
(12) Patent Application Publication
(10) Pub. No.: US 2019/0140961 A1
(43) Pub. Date: May 9, 2019

(54) QUALITY OF SERVICE CONTROL SYSTEM AND QUALITY OF SERVICE CONTROL METHOD

(71) Applicant: INSTITUTE FOR INFORMATION INDUSTRY, Taipei City (TW)

(72) Inventors: Chia-Hong WANG, Taipei City (TW); Teng-Chang CHANG, Taipei City (TW)

(73) Assignee: INSTITUTE FOR INFORMATION INDUSTRY, Taipei City (TW)

(21) Appl. No.: 15/835,635

(22) Filed: Dec. 8, 2017

(30) Foreign Application Priority Data
Nov. 3, 2017 (TW) 106138028

(51) Int. Cl. H04L 12/833; H04L 12/749; H04L 12/851

(52) U.S. Cl. CPC H04L 47/2458; H04L 45/302; H04L 47/2441; H04L 45/741

(57) ABSTRACT

A quality of service control system includes an input device, a processing unit and an output device. The input device receives a packet. The processing unit obtains an Internet Protocol (IP) version and adds at least one extension column in an undefined IP header, so as to generate a quality of service control packet. The output device transmits the quality of service control packet. Similarly, an input device receives the quality of service control packet and achieves the effect of transmitting the packet with higher priority, determining a transmission rate and keeping data accessed for a specific time according to a packet rate control parameter configuration in the quality of service control packet.

This application claims the benefit of Taiwan application Serial No. 106138028, filed Nov. 3,2017, the subject matter of which is incorporated herein by reference.

### FIELD OF DISCLOSURE

The present disclosure relates to a quality of service control system and a quality of service control method. More particularly, the present disclosure relates to a quality of service control system and a quality of service control method capable of extending at least one extension column.

### DESCRIPTION OF RELATED ART

In general, when a lot of networking devices connect to the network simultaneously in Internet of thing, their network packets will bypass through at least one relay node to the destination terminal. The strategy of the relay node is First-In-First-out and buffer scheduling.

Usually, under the condition that the relay node is not busy, all the passed packets are able to be transmitted smoothly. However, when the packets pass in and out of the relay node frequently (on the condition of busy) or the network is unstable, it occurs that the packet with higher requirement of immediacy and transmission rate fails to be transmitted immediately, or the packet fails to be transmitted to the destination on time since it waits too long time for the queue in the relay node; or the relay node lose the packet and has to retransmit the packet due to the unstable network.

Therefore, how to provide a quality of service system or method thereof capable of effectively transmitting the packet with higher priority, ensuring the transmission rate and keeping the data packet for a specific time for reducing the burden of retransmission has become a problem for one of ordinary skill in the art to solve.

### SUMMARY

One aspect of the present disclosure is related to a quality of service control system. The quality of service control system includes an input device, a processing unit and an output device. The input device is configured for receiving a packet. The processing unit is configured for obtaining an IP (Internet Protocol) version of the packet and adding at least one extension column in an undefined IP header of the IP version of the packet, so as to generate a quality of service control packet. The output device is configured for transmitting the quality of service control packet.

Another one aspect of the present disclosure is related to a quality of service control method. The quality of service control method includes: receiving a packet; obtaining an IP (Internet Protocol) version of the packet and adding at least one extension column in an undefined IP header of the IP version of the packet, so as to generate a quality of service control packet; transmitting the quality of service control packet.

To sum up, the present disclosure is able to enhance the service quality of the internet packet by adding the undefined header definition under the existing Internet Protocol standards. Accordingly, the present disclosure is to provide a quality of service control system and a quality of service control method, which are able to effectively transmit the packet with the higher priority, ensure the transmission rate and keeping the data packet for a specific time for reducing the burden of retransmission.

### BRIEF DESCRIPTION OF THE DRAWINGS

FIG. 1 is a schematic diagram of a quality of service control system according to one embodiment of the present disclosure.

FIG. 2 is a flowchart of a quality of service control method according to one embodiment of the present disclosure.

FIG. 3 is a schematic diagram of a packet structure of a header of IPv4 (Internet Protocol version 4) with an added optional header according to one embodiment of the present disclosure.

FIG. 4 is a schematic diagram of an extension column used in a packet of IPv4 according to one embodiment of present disclosure.

FIG. 5 is a schematic diagram of a packet structure of a header of IPv6 (Internet Protocol version 6) with an added extension header according to one embodiment of the present disclosure.

FIGS. 6A-6B are schematic diagrams of an extension header added in a header of IPv6 according to one embodiment of present disclosure.

FIGS. 7A-7B are schematic diagrams of header type/protocol functions corresponding to various the header codes of IPv6 according to one embodiment of present disclosure.

FIG. 8 is a schematic diagram of an extension column of IPv6 according to one embodiment of present disclosure.

FIGS. 9A-9B are flowcharts of a quality of service control method according to one embodiment of present disclosure.

### DETAILED DESCRIPTION OF DISCLOSED EMBODIMENTS

Reference will now be made in detail to the present embodiments of the disclosure, examples of which are illustrated in the accompanying drawings. Wherever possible, the same reference numbers are used in the drawings and the description to refer to the same or like parts.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, when an element is referred to as being “connected” or “electrically connected” to another element, it can be directly connected to the other element or intervening elements may be present. In contrast, when an element is referred to as being “directly connected” to another element, there are no intervening elements present. Moreover, “electrically connect” or “connect” can further refer to the interoperation or interaction between two or more elements.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, unless otherwise defined, all terms (including technical and scientific terms) have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any element in a claim that does not explicitly state “means for” performing a specified function, or “step for” performing a specific function, is not to be interpreted as a “means” or “step” clause as specified in 35 U.S.C. § 112(f). In particular, the use of “step of” in the claims herein is not intended to invoke the provisions of 35 U.S.C. § 112(f).

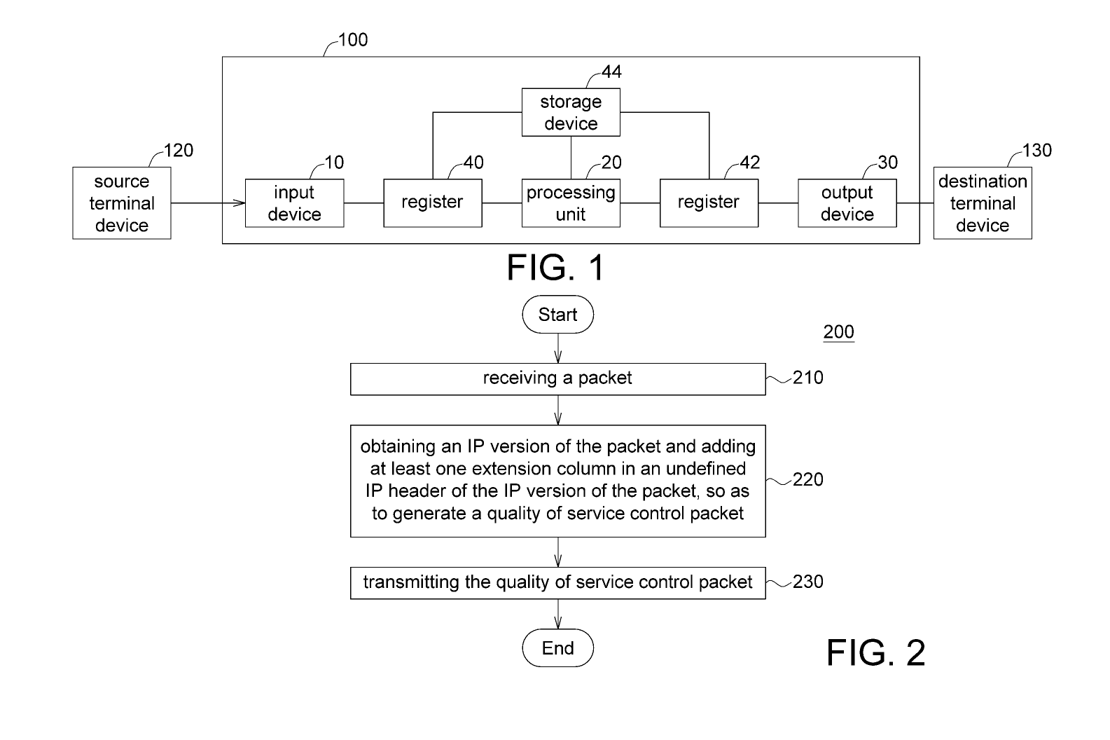

Reference is made to FIGS. 1. FIG. 1 is a schematic diagram of a quality of service control system 100 according to one embodiment of the present disclosure. In one embodiment, the quality of service control system 100 includes an input device 10, a processing unit 20 and an output device 30. In one embodiment, the quality of service control system 100 may be a relay node, such as a router, a gateway or a network switch.

In one embodiment, the input device 10 and the output device 30 may be implemented by the software, such as a user interface, or implemented by the hardware, such as a substantial network interface card or other electronic devices capable of receiving signals. In one embodiment, the processing unit 20 may be implemented by a microcontroller, a microprocessor, a digital signal processor, an application specific integrated circuit (ASIC), or a logic circuit.

In one embodiment, the quality of service control system 100 is able to receive the information from the source terminal device 120. The source terminal device 120 may be a mobile phone, a tablet, a station base, a personal computer, a server, or any electronic device with the transmission function.

In one embodiment, the quality of service control system 100 further includes registers 40 and 42, and a storage device 44. In one embodiment, the registers 40 and 42 may be implemented by buffers. In another embodiment, the registers 40 and 42 may be viewed as a partial storage region of the storage device 44. In one embodiment, the storage device 44 can be implemented by memory, hard disk, memory card, or a storage medium having the same function, etc.

In one embodiment, the output device 30 is able to transmit a quality of service control packet to a destination terminal device 130. The destination terminal device 130 may be a mobile phone, a tablet, a station base, a personal computer, a server, or any electronic device with the transmission function.

Reference is made to FIG. 1 and FIG. 2. FIG. 2 is a flowchart of a quality of service control method 200 according to one embodiment of the present disclosure.

In operation 210, the input device 10 receives a packet. In one embodiment, the input device 10 receives the packet from the source terminal device 120 or other relay nodes, in which the IP (Internet Protocol) version of this packet may be IPv4 (Internet Protocol version 4) or IPv6 (Internet Protocol version 6). These two versions of packets have different header formats. Therefore, the quality of service control system 100 executes the corresponding decoding in accordance with the header formats of different IP versions to obtain or add the information.

In embodiment, the input device 10 stores the received packet in the register 40.

In operation 220, the processing unit 20 is configured for obtaining an IP version of the packet and adding at least one extension column in an undefined IP header of the IP version of the packet, so as to generate a quality of service control packet.

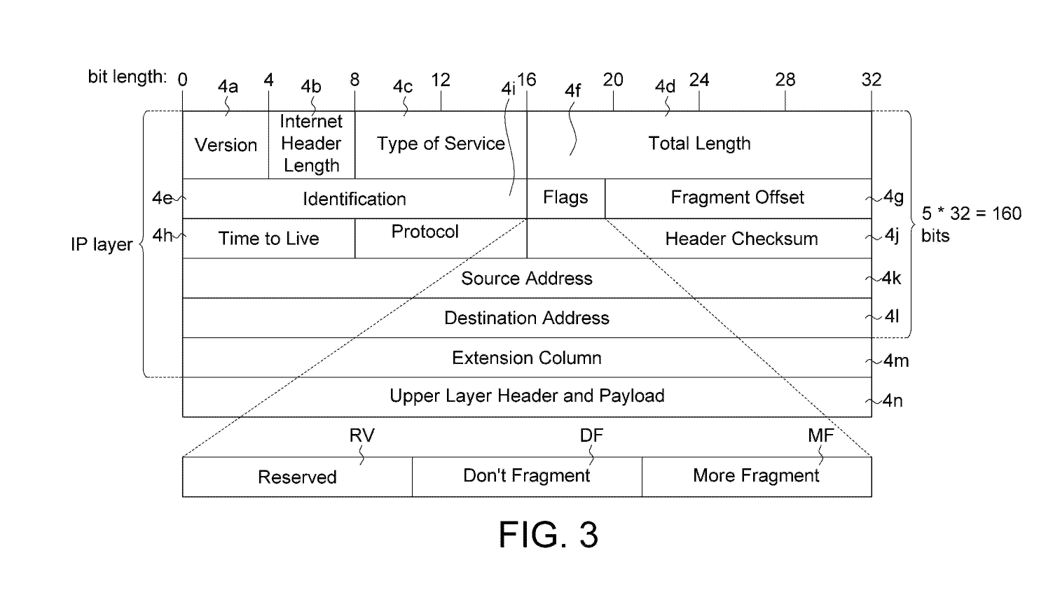

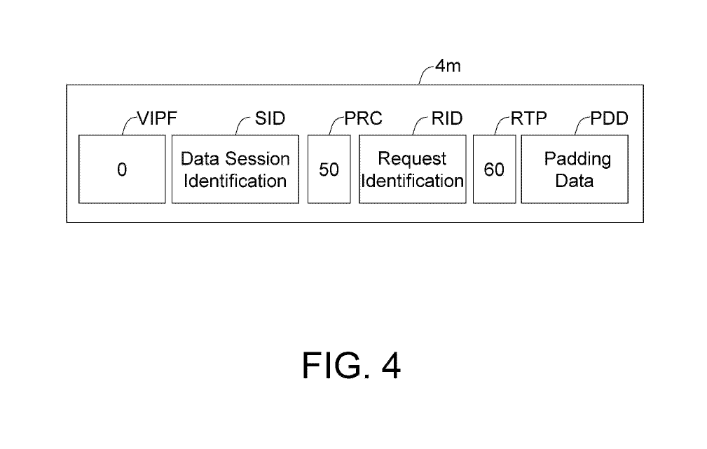

Reference is made to FIG. 3 and FIG. 4. FIG. 3 is a schematic diagram of a packet structure of a header of IPv4 (Internet Protocol version 4) with an added optional header according to one embodiment of the present disclosure. FIG. 4 is a schematic diagram of an extension column used in a packet of IPv4 according to one embodiment of present disclosure.

In FIG. 3, the header length of the initial IPv4 is 32bits multiplying 5 (total 160 bits) and includes columns 4a-4n, in which the column 4a is the version column used for showing the version of the packet (when the IP version of the packet is IPv4, the content of the column 4a is “4”); the column 4b is used for representing the internet header length (IHL); the column 4c is used for representing the type of service; the column 4d is used for representing the total length of the packet; the column 4e is used for representing the identification code; the column 4f is the flag column used for representing several flags and including 3 bits which are the Reserved bit (RV), the Don't Fragment bit (DF), and the More Fragment bit (MF), respectively, in which the MF bit and the DF bit are used for marking whether this packet is fragmented, and the RV bit is able to be set as 0 or 1, this part will be described in detail afterwards; the column 4g is used for representing the fragment offset; the column 4h is used for the time to live (TTL) of this packet in the quality of service control system 100 (e.g., the Network Switch); the column 4i is used for representing the internet protocol (IP) of this packet; the column 4j is sued for representing the header checksum code; the column 4k is used for representing the source IP address; the column 41 is used for representing the destination IP address; the column 4m is optional extension column, such as the optional and padding column of the original IPv4, of which the length is the multiple of 32 bits; the column 4n represents the upper layer header and payload. In one embodiment, the columns 4a-4n all located in the IP layer. The method for adding the extension column in the header of the IPv4 is described in detail below.

In one embodiment, when the header length described in the column 4b is greater than 5, it represents that this header includes the extension column 4m. More specifically, the initial header length is 5. As the extension column, the header length may be represented as “5+X”, in which when the packet rate control parameter X is a packet rate control parameter greater than 0, the packet rate control parameter X represents the size of the extension column, for example, when the packet rate control parameter X is 0, it represents that this header doesn't have the extension column and its length is initial 160 (i.e., 5*32) bits; when the packet rate control parameter X is 1, it represents that one 32 bits column is extended and the length of this header becomes 6*32 bits, i.e., 192 bits. Accordingly, by changing or setting this packet rate control parameter X, the size of the extension column (i.e., the column 4m) is able to be adjusted.

In one embodiment, when the processing unit 20 wants to set the received packet as the quality of service control packet, the processing unit 20 sets a header length of the packet (e.g., setting the header length greater than 5), modifies the value of the reserved bit RV as 1, and adds at least one extension column 4m in this packet according to the header length, so as to generate the quality of service control packet. The at least one extension column 4m is located in an option and padding column of the header.

In one embodiment, the reserved bit RV is in the undefined column of the existing IPv4. When the value of the reserved bit RV is 1, it represents the undefined column 4m is used, in other words, this packet is set as the quality of service control packet; when the value of reserved bit RV is 0, it represents that this packet doesn't use the undefined column 4m. In other words, this packet is not set as the quality of service control packet.

Therefore, by modifying the value of the undefined column to add the extension column in the packet according to the above method, the packet is set as the quality of service control packet.

Reference is made to FIG. 4. The content of the extension column 4m includes at least one of a priority level parameter VIPF, a retaining parameter RTP, and a packet rate control parameter PRC. In one embodiment, the extension column 4m includes the padding data (PDD) column representing the unassigned bit. Accordingly, the header is able to define the priority, the retain time, and/or the transmission rate of the quality of service control packet.

In one embodiment, the priority level parameter VIPF may be one of 0 to 2. The higher the priority level is, the greater the priority level parameter VIPF is.

In one embodiment, the retaining parameter RTP is used for setting the time, in which the quality of service control packet corresponding to a request identification code needs to be reserved, e.g., 60 seconds.

In one embodiment, the packet rate control parameter PRC of the quality of service control packet is used for setting a continuous output time period of the quality of service control packet with the same data session identification code, e.g., 50 milliseconds.

In one embodiment, the content of the extension column 4m includes a data session identification code SID and/or a request identification code RID. The data session identification code SID is the identification code related to the communication establishment, which is able to identify the packet data with the same transmission rate. The request identification code RID is used for representing the identification code of request function or service.

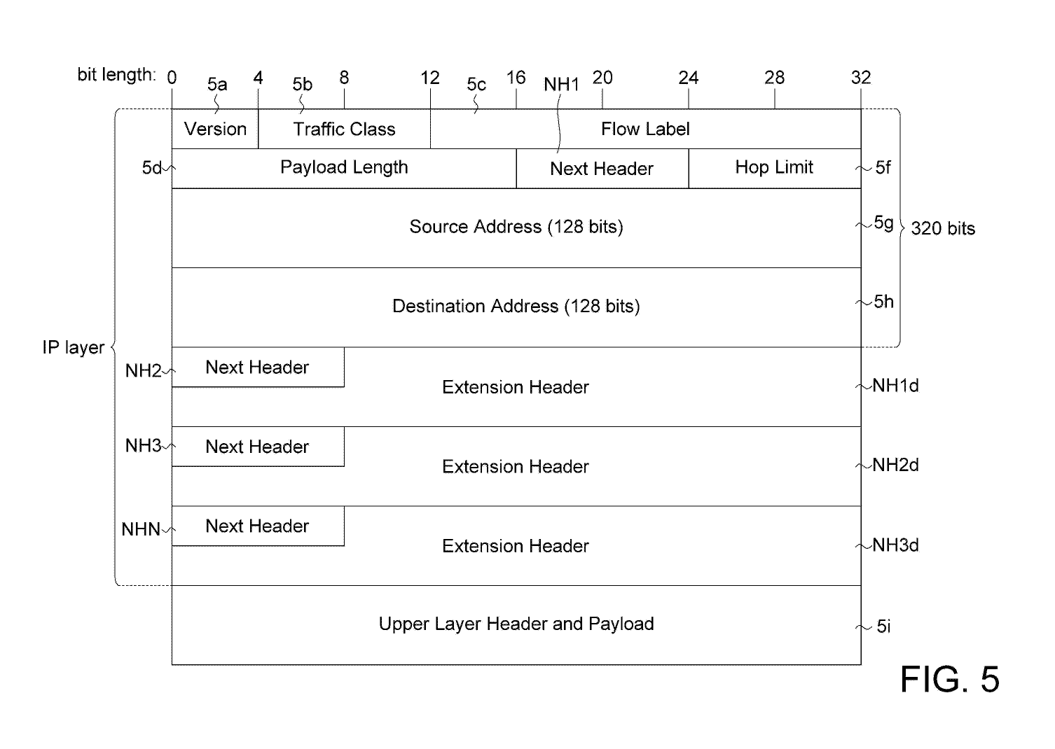

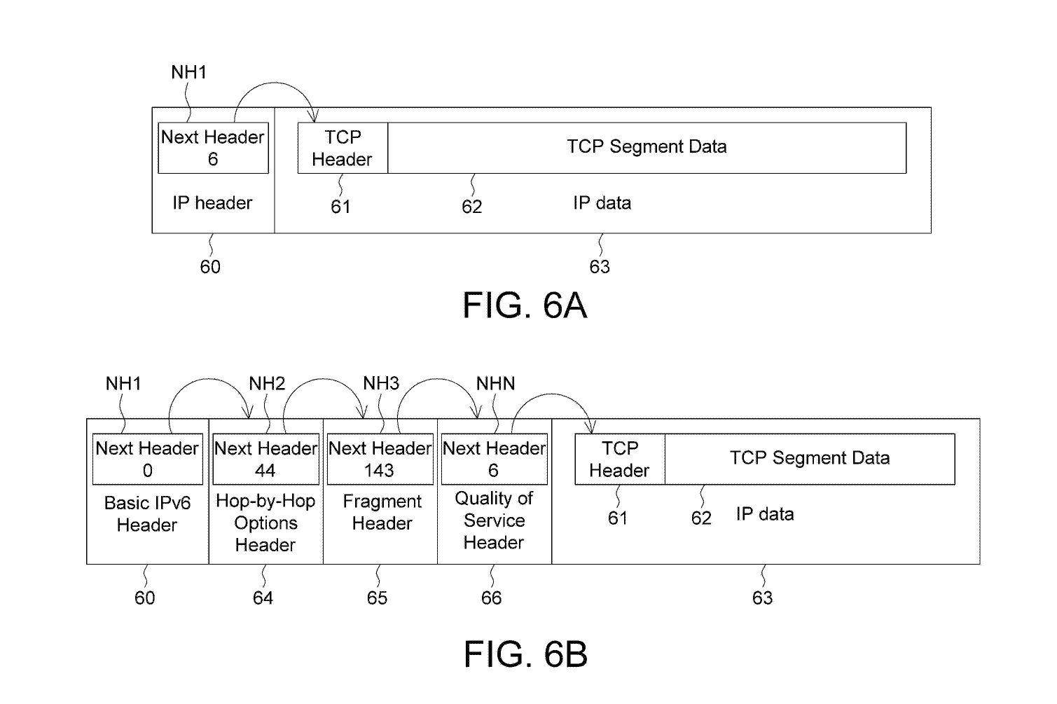

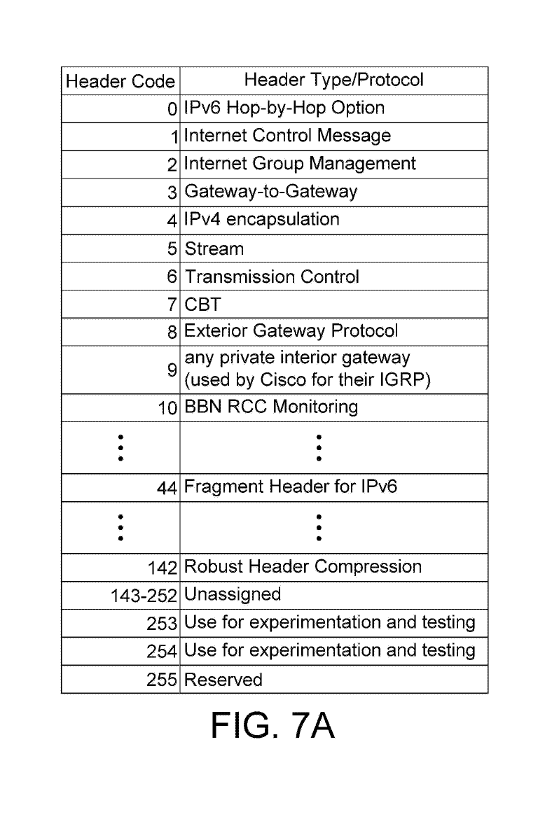

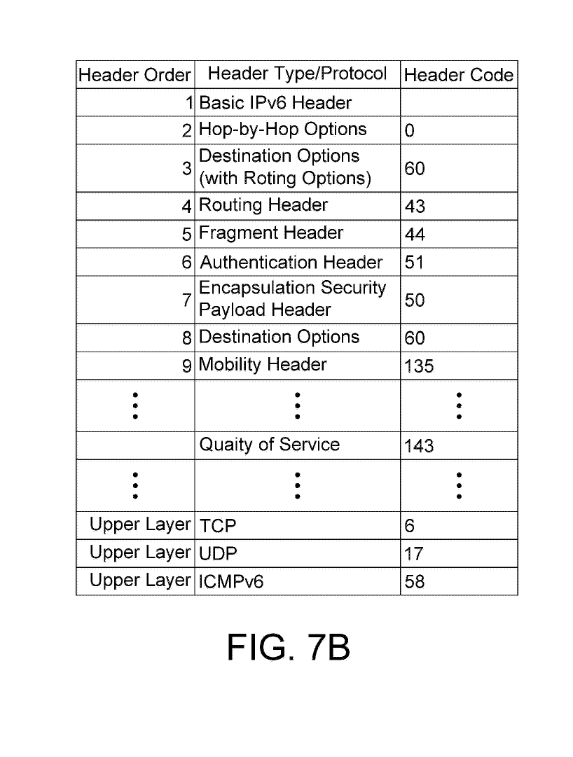

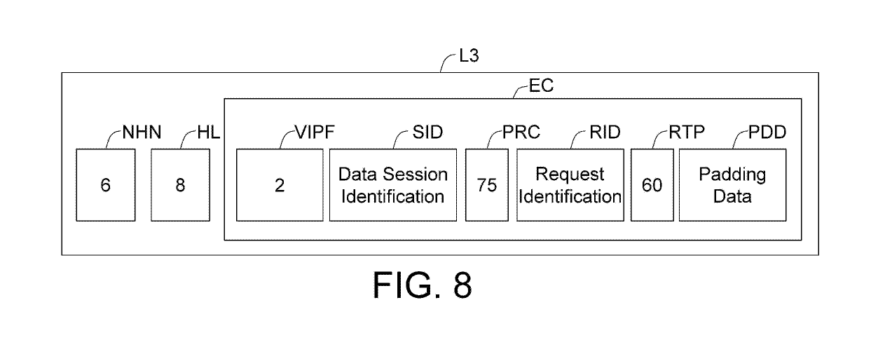

The above contents describe the method for extending the header of IPv4. Next, the method for extending the header of IPv6 is described as below. Reference is made to FIG. 5, FIG. 6A-6B, FIG. 7, and FIG. 8. FIG. 5 is a schematic diagram of a packet structure of a header of IPv6 (Internet Protocol version 6) with an added extension header according to one embodiment of the present disclosure. FIG. 6A-6B are schematic diagrams of an extension header added in a header of IPv6 according to one embodiment of present disclosure. FIG. 7A-7B are schematic diagrams of header type/protocol functions corresponding to various codes of the headers of IPv6 according to one embodiment of present disclosure. FIG. 8 is a schematic diagram of an extension column of IPv6 according to one embodiment of present disclosure.

In FIG. 5, the original IPv6 includes columns 5a-5i, in which the column 5a is used for representing the IP version (when the IP version of the packet is IPv6, the content of the column 5a is 6); the column 5b is used for representing the traffic class; the column 5c is used for representing the flow label; the column 5d is used for representing the payload length; the column NH1 is used for representing the next header, e.g., appointing the next header is the extension header NH1d; the column 5f is used for representing the hop limit; the column 5g is used for representing the source IP address; the column 5h is used for representing the destination IP address. The extension header NH1d includes a next header NH2, and the content of the next header NH2 is used for pointing to a next extension header NH2d. The extension header NH2d includes a next header NH3, and the content of the next header NH3 is used for pointing to an added extension header NH3d. The extension header NH3d includes an added next header NHN. The added next header NHN is used for pointing to a next extension header or the transport layer header. In one embodiment, the transport layer header points to the column 5i, and the column 5i represents the upper layer header and payload.

In one embodiment, the columns 5g and 5h occupy 128 bits, respectively, and the columns 5a-5h totally occupy 320 bits. The columns 5g-5h and the next header NH1, NH2, and NHN are located in the IP layer.

In one embodiment, when the processing unit 20 determines that the IP version of the packet is IPv6, the processing unit 20 adds a first extension header (e.g., the extension header NH3d) in the packet, in which the extension header NH3d points to a second extension header (may be another added extension header) or a transport layer header (e.g., the header of the column 5i represented as the upped layer header and payload) by a code of a next header (e.g., the next header NHN).

In one embodiment, the first extension header (e.g., the extension header NH3d) is located previous to the upper layer header and payload (e.g., the column 5i).

In one embodiment, the second extension header represents the next extension header of the first extension header, and the header code corresponds to a protocol function of the second extension header. The more specific embodiments are provided and described in detail below.

In one embodiment, as shown in FIG. 6A, when the processing unit 20 determines that the IP version of the packet is IPv6, the processing unit 20 sets the header code of the next header NH1 of the IP header 60 as 6. As shown in FIG. 7, the protocol function corresponding to the header code set as 6 is Transmission Control Protocol (TCP), and it represents that the next header NH1 directly points to the TCP header 61, which is linked to the TCP data. The TCP header 61 and the TCP data both are included in the IP data 63, in which the IP data 63 represents the column 5i in FIG. 5.

In one embodiment, reference is made to FIG. 5, FIG. 6, and FIG. 7A-7B. FIG. 7A shows the protocol functions corresponding to the original header codes (FIG. 7 is a schematic diagram not showing all header codes), in which the header codes 143-252 are not defined and the header code 255 is the reserved. Therefore, the processing unit 20 is able to define the function related to the quality of service in the extension columns of these unassigned header codes 143-252 and 255. On the other hand, FIG. 7b shows the protocol functions corresponding to the header codes with the added extension columns, in which the list order only represents the number of each column.

When the processing unit 20 determines that the IP version of the packet is IPv6, the processing unit 20 sets the header code of the next header NH1 in the basic header 60 of the IPv6 as 0. As shown I FIG. 7B, the protocol function corresponding to the header code as 0 is Hop-by-Hop Options of IPv6, it represents the function of the first extension header NH1d is Hop-by-Hop Options (as shown in FIG. 5). The header code of the next header NH2 in the Hop-by-Hop Options header 64 of the extension header is 44. As shown in FIG. 7, the protocol function corresponding to the header code as 44 is Fragment Header of the extension header, it represents that the function of the second extension header is Fragment Header of the extension header (as shown in FIG. 5). The header code of the next header NH3 in the Fragment Header 65 of the extension header is 143. As shown in FIG. 7A, the header code as 143 is unassigned originally. Therefore, the protocol function corresponding to the header code as 143 is able to be modified as pointing to the quality of service control header 66 of the extension header (as shown in FIG. 6B). The modified protocol function corresponding to the header code as 143 is shown in FIG. 7B.

The header code of the next header NHN in the quality of service control header 66 of the extension header is 6. The protocol function corresponding to the header code as 6 is TCP. The next header NHN directly points to the TCP header 61, which is linked to the TCP data 62. The TCP header 61 and the TCP data both are included in the IP data 63.

In one embodiment, the Hop-by-Hop options header 64 of the extension header, the Fragment header 65 of the extension header, and the quality of service control header 66 of the extension header are able to be the extension columns. In one embodiment, the basic header 60 of the IPv6, he Hop-by-Hop options header 64 of the extension header, the Fragment header 65 of the extension header, and the quality of service control header 66 of the extension header are included in the IP header. In one embodiment, the protocol functions corresponding to the header codes as 143-252, and 255 all are able to be modified as the quality of service control header 66 of the extension header, and the function related to the quality of service is able to be defined in the extension columns of the quality of service control header 66 of the extension header.

In one embodiment, as shown in FIG. 8, the extension header (which is corresponding to the extension header NH3d in FIG. 5) includes at least one extension column EC. The content of the extension column EC includes at least one of a priority level parameter VIPF, a retaining parameter RTP, and a packet rate control PRC. In one embodiment, the extension column EC further includes a padding column PDD representing the unassigned bit.

Accordingly, this header is able to define the priority, the retained time, and/or the transmission rate of the quality of service control packet. In one embodiment, the extension header further includes the next header NHN and the header length HL.

In one embodiment, the content of the extension column EC includes the data session identification code SID and/or the request identification code RID. The data session identification code SID is the identification code related to the communication establishment, which is able to identify the packet data with the same transmission rate. The request identification code RID is used for representing the identification code of request function or service.

It is noted that the present disclosure is not only limited in adding one extension header NH3d, but also it is able to add several extension columns.

By the aforementioned operations, the processing unit 20 is able to add the extension header NH3d in the received packet for recording information related to the quality of service control, so as to generate the quality of service control packet. Moreover, the aforementioned columns without specific illustration are defined by the header of the known IP version, and thus no more detailed description thereto.

In one embodiment, the processing unit 20 stores the quality of service control packet in the storage device 44, and sends the quality of service control packet to the register 42 when the quality of service control packet is about to be transmitted.

In operation 230, the output device 30 transmits the quality of service control packet. For example, the output device 30 reads the quality of service control packet from the register 42 and transmits the quality of service control packet to the next transmission node.

The above contents describe the method for adding the extension column in the packet to generate the quality of service control packet after the processing unit 20 receives the packet. The method for analyzing the quality of service control packet and obtaining the packet rate control parameters of the quality of service control packet after the processing unit 20 receives the quality of service control packet is described as below.

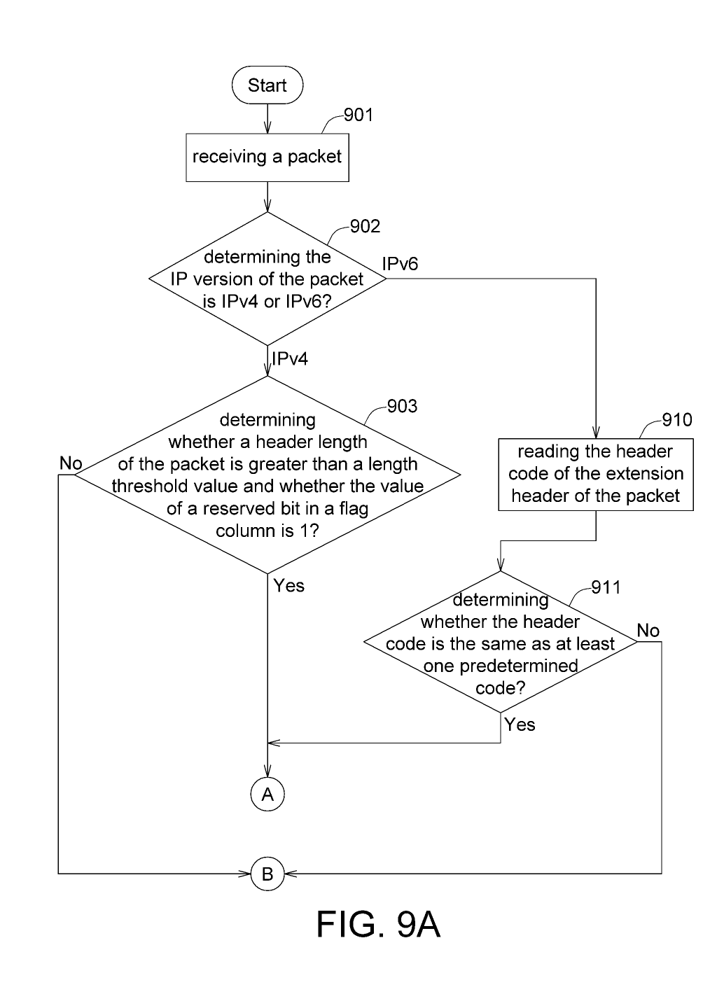

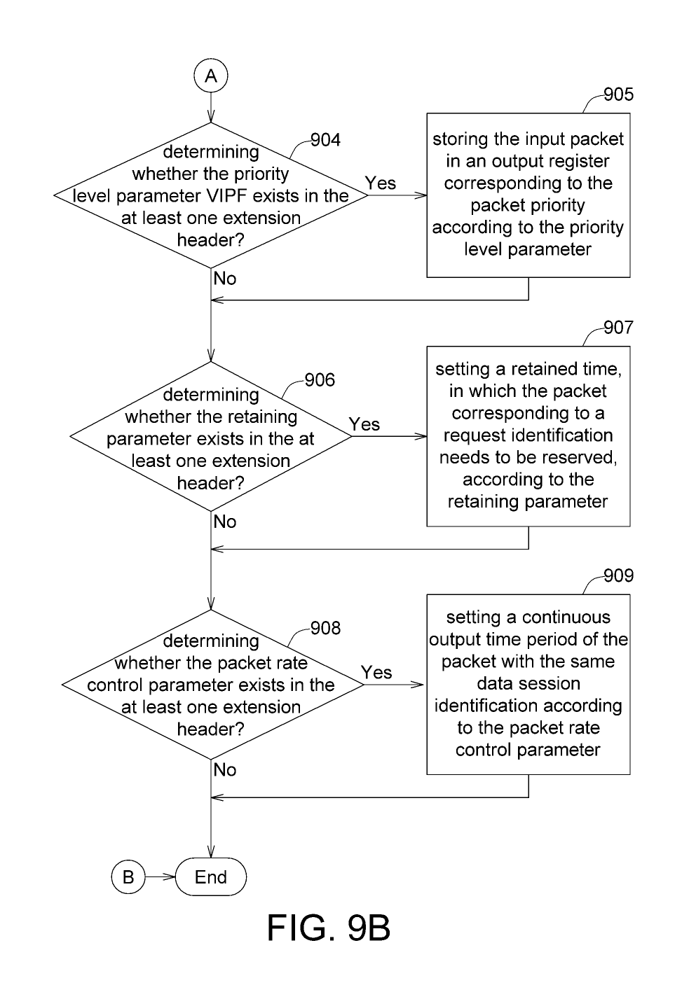

Reference is made to FIG. 9A-9B. FIG. 9A-9B are flowcharts of a quality of service control method 900 according to one embodiment of present disclosure.

In operation 901, the input device 10 receives a packet. In one embodiment, the input device 10 stores the received packet in the register 40, and the processing unit 20 reads this packet from the register 40.

In operation 902, the processing unit 20 determines whether the IP version of the packet is IPv4 or IPv6 according to the version column of the packet. When the processing unit 20 determines that the IP version of the packet is IPv4, operation 903 is executed; when the processing unit 20 determines that the IP version of the packet is IPv6, operation 910 is executed.

In operation 903, the processing unit 20 determines whether a header length of the packet is greater than a length threshold value (e.g., 5) and whether the value of a reserved bit in a flag column (e.g., the flag column 4f) is 1 (representing that this packet includes the packet rate control parameters related to the quality of service control packet). When the processing unit 20 determines that the header length of the packet is greater than the length threshold value and the value of the reserved bit in the flag column is 1, the packet is determined as the quality of service control packet. The processing unit 20 further reads the content of the extension column in the quality of service control packet, and then operation 904 is executed.

In operation 904, the processing unit 20 determines whether the priority level parameter VIPF exists in the at least one extension column. When the processing unit 20 determines that the priority level parameter VIPF exists in the at least one extension column, operation 905 is executed; when the processing unit 20 determines that the priority level parameter VIPF does not exist in the at least one extension column, operation 906 is executed.

In operation 905, the processing unit 20 schedules a packet priority of the quality of service control packet according to the priority level parameter VIPF, and stores the quality of service control packet in an output register (e.g., the register 42) corresponding to the packet priority. In one embodiment, the range of the priority level parameter is between 0 and 2. The higher the priority is, the greater the priority level parameter is. Accordingly, the processing unit 20 is able to select the quality of service control packet with higher priority, and arrange it in the high-speed transmission channel or arrange it in the front terminal of the to-be transmitted packet sequence.

In operation 906, the processing unit 20 determines whether the retaining parameter RTP exists in the at least one extension column. When the processing unit 20 determines that the retaining parameter RTP exists in the at least one extension column, operation 907 is executed. When the processing unit 20 determines that the retaining parameter RTP does not exist in the at least one extension column, operation 908 is executed.

In operation 907, the processing unit 20 calculates a retained time, in which the quality of service control packet corresponding to a request identification code needs to be reserved, according to the retaining parameter RTP. In other words, the retaining parameter RTP is used for reserving the quality of service control packet in the register 42 or the storage device 44 within the retained time. When the processing unit 20 receives a packet request with the same request identification code as the quality of service control packet, the processing unit 20 retransmits the reserved quality of service control packet to a demand device that sends the packet request.

In operation 908, the processing unit 20 determines whether the packet rate control parameter PRC exists in the at least one extension column. When the processing unit 20 determines that the packet rate control parameter PRC exists in the at least one extension column, operation 909 is executed; when the processing unit 20 determines that the packet rate control parameter PRC does not exist in the at least one extension column, the flow is ended.

In operation 909, the processing unit 20 sets a continuous output time period of the quality of service control packet with the same data session identification code according to the packet rate control parameter PRC.

On the other hand, in operation 910, the processing unit 20 reads the header code of the extension header in the packet.

In operation 911, the processing unit 20 determines whether the header code is the same as at least one predetermined code. In one embodiment, as shown in FIG. 7, the at least one predetermined code means the header code corresponding to the function of the unassigned or the reserved header code 143-252 and 255. When the header code is the same as the at least one predetermined code, the packet is determined as the quality of service control packet, and operation 904 is executed, otherwise the flow ends. Next, operations 904-909 are described above and thus no more detailed description thereto.

It is noted that the present disclosure is not limited in the order of the aforementioned operations. The order of the operations 904, 906 and 908 can be changed, or these determinations are able to be executed simultaneously.

To sum up, the present disclosure identifies the IP version of the packet and adds the undefined headers according to the IP version of the packet, so as to enhance the quality of service packet. Since the present disclosure completes decoding in the IP layer (the 3^{rd} layer) rather than the transport layer (the 4^{th} layer), the present disclosure provides a quality of service control system and a quality of service control method, which are able to effectively transmit the packet with the higher priority, ensure the transmission rate and keeping data accessed for a specific time. Moreover, the present disclosure adopts the packet structure complied with Internet Protocol, and completes adding the column on the condition that the packet structure complies with Internet Protocol. Therefore, it is able to extend the quality of packet service without affecting the transmission of the normal packet.

Although the present disclosure has been described in considerable detail with reference to certain embodiments thereof, other embodiments are possible. Therefore, the scope of the appended claims should not be limited to the description of the embodiments contained herein.

What is claimed is:

1. A quality of service control system, comprising:
an input device configured for receiving a packet;
a processing unit configured for obtaining an IP (Internet Protocol) version of the packet and adding at least one extension column in an undefined IP header of the IP version of the packet, so as to generate a quality of service control packet; and
an output device configured for transmitting the quality of service control packet;
wherein a content of the at least one extension column comprises at least one of a priority level parameter, a retaining parameter and a packet rate control parameter.

2. The quality of service control system of claim 1, wherein when the processing unit determines that the IP version of the packet is IPv4 (Internet Protocol version 4), the processing unit sets a header length of the packet, modifies the value of a reserved bit in a flag column as 1, and adds the at least one extension column in the packet according to the header length, so as to generate the quality of service control packet, wherein the at least one extension column is located in an option and padding column.

3. The quality of service control system of claim 1, wherein when the processing unit determines that the IP version of the packet is IPv4, the processing unit is further configured for determining whether a header length of the packet is greater than a length threshold value and whether the value of a reserved bit in a flag column is 1;
when the processing unit determines that the header length of the packet is greater than the length threshold value and the value of the reserved bit in the flag column is 1, the packet is determined as the quality of service control packet, and the processing unit determines whether the priority level parameter exists in the at least one extension column; and
when the processing unit determines that the priority level parameter exists in the at least one extension column, the processing unit schedules a packet priority of the quality of service control packet according to the priority level parameter, and stores the quality of service control packet in an output register corresponding to the packet priority.

4. The quality of service control system of claim 1, wherein when the processing unit determines that the IP version of the packet is IPv4, the processing unit is further configured for determining whether a header length of the packet is greater than a length threshold value and whether the value of a reserved bit in a flag column is 1;
when the processing unit determines that the header length of the packet is greater than the length threshold value and the value of the reserved bit in the flag column is 1, the packet is determined as the quality of service control packet, and the processing unit determines whether the retaining parameter exists in the at least one extension column; and
when the processing unit determines that the retaining parameter exists in the at least one extension column, the processing unit calculates a retained time in which the quality of service control packet is stored in a register, reserves the quality of service control packet in the register within the retained time, wherein when a packet request with the same request identification code as the quality of service control packet is received, the processing unit retransmits the reserved quality of service control packet to a demand device that sends the packet request.

5. The quality of service control system of claim 1, wherein when the processing unit determines that the IP version of the packet is IPv4, the processing unit is further configured for determining whether a header length of the packet is greater than a length threshold value and whether the value of a reserved bit in a flag column is 1;
when the processing unit determines that the header length of the packet is greater than the length threshold value and the value of the reserved bit in the flag column is 1, the packet is determined as the quality of service control packet, and the processing unit determines whether the packet rate control parameter exists in the at least one extension column; and
when the processing unit determines that the packet rate control parameter exists in the at least one extension column, the processing unit sets a continuous output time period of the quality of service control packet with the same data session identification code according to the packet rate control parameter.

6. The quality of service control system of claim 1, wherein when the processing unit determines that the IP version of the packet is IPv6 (Internet protocol version 6), the processing unit adds a first extension header in the packet, in which the first extension header points to a second extension header or a transport layer header by a header code of a next header, so as to generate the quality of service control packet;
wherein the first extension header is located previous to an upper layer header and payload;
wherein the second header represents the extension header next to the first extension header, and the header code corresponds to a protocol function of the second extension header.

7. The quality of service control system of claim 6, wherein the first extension header comprises the at least one extension column.

8. The quality of service control system of claim 1, wherein when the processing unit determines that the IP version of the packet is IPv6, the processing unit is further configured for reading a header code of a first extension header of the packet, and determining whether the header code is the same as at least one predetermined code;
when the header code is the same as the at least one predetermined code, the packet is determined as the quality of service control packet, and the processing unit determines whether the priority level parameter exists in the at least one extension column; and
when the processing unit determines that the priority level parameter exists in the at least one extension column, the processing unit schedules a packet priority of the quality of service control packet according to the priority level parameter, and stores the quality of service control packet in an output register corresponding to the packet priority.

9. The quality of service control system of claim 1, wherein when the processing unit determines that the IP version of the packet is IPv6, the processing unit is further configured for reading a header code of a first extension header of the packet, and determining whether the header code is the same as at least one predetermined code;
when the header code is the same as the at least one predetermined code, the packet is determined as the quality of service control packet, and the processing unit determines whether the retaining parameter exists in the at least one extension column; and
when the processing unit determines that the retaining parameter exists in the at least one extension column, the processing unit calculates a retained time in which the quality of service control packet is stored in a register, reserves the quality of service control packet in the register within the retained time, wherein
when a packet request with the same request identification code as the quality of service control packet is received, the processing unit retransmits the reserved quality of service control packet to a demand device that sends the packet request.

10. The quality of service control system of claim 1, wherein when the processing unit determines that the IP version of the packet is IPv6, the processing unit is further configured for reading a header code of a first extension header of the packet, and determining whether the header code is the same as at least one predetermined code;
when the header code is the same as the at least one predetermined code, the packet is determined as the quality of service control packet, and the processing unit determines whether the packet rate control parameter exists in the at least one extension column; and
when the processing unit determines that the packet rate control parameter exists in the at least one extension column, the processing unit sets a continuous output time period of the quality of service control packet with the same data session identification code according to the packet rate control parameter.

11. A quality of service control method, comprising:
receiving a packet;
obtaining an IP version of the packet and adding at least one extension column in an undefined IP header of the IP version of the packet, so as to generate a quality of service control packet; and
transmitting the quality of service control packet;
wherein a content of the at least one extension column comprises at least one of a priority level parameter, a retaining parameter and a packet rate control parameter.

12. The quality of service control method of claim 11, further comprising:
determining the IP version of the packet;
when the IP version of the packet is determined as IPv4, setting a header length of the packet, modifying the value of a reserved bit in a flag column as 1, and adding the at least one extension column in the packet according to the header length, so as to generate the quality of service control packet, wherein the at least one extension column is located in an option and padding column.

13. The quality of service control method of claim 11, further comprising:
determining the IP version of the packet;
when the IP version of the packet is determined as IPv4, determining whether a header length of the packet is greater than a length threshold value and whether the value of a reserved bit in a flag column is 1;
when the header length of the packet is determined as greater than the length threshold value and the value of the reserved bit in the flag column is determined as 1, determining the packet as the quality of service control packet, and determining whether the priority level parameter exists in the at least one extension column; and
when the priority level parameter is determined as existing in the at least one extension column, scheduling a packet priority of the quality of service control packet according to the priority level parameter, and storing the quality of service control packet in an output register corresponding to the packet priority.

14. The quality of service control method of claim 11, further comprising:
determining the IP version of the packet;
when the IP version of the packet is determined as IPv4, determining whether a header length of the packet is greater than a length threshold value and whether the value of a reserved bit in a flag column is 1;
when the header length of the packet is determined as greater than the length threshold value and the value of the reserved bit in the flag column is determined as 1, determining the packet as the quality of service control packet, and determining whether the retaining parameter exists in the at least one extension column; and
when the retaining parameter is determined as existing in the at least one extension column, calculating a retained time in which the quality of service control packet is stored in a register, reserves the quality of service control packet in the register within the retained time, wherein when a packet request with the same request identification code as the quality of service control packet is received, retransmitting the reserved quality of service control packet to a demand device that sends the packet request.

15. The quality of service control method of claim 11, further comprising:
determining the IP version of the packet;
when the IP version of the packet is determined as IPv4, determining whether a header length of the packet is greater than a length threshold value and whether the value of a reserved bit in a flag column is 1;
when the header length of the packet is determined as greater than the length threshold value and the value of the reserved bit in the flag column is determined as 1, determining the packet as the quality of service control packet, and determining whether the packet rate control parameter exists in the at least one extension column; and
when the packet rate control parameter is determined as existing in the at least one extension column, setting a continuous output time period of the quality of service control packet with the same data session identification code according to the packet rate control parameter.

16. The quality of service control method of claim 11, further comprising:
determining the IP version of the packet;
when the IP version of the packet is determined as IPv6, adding a first extension header in the packet, in which the first extension header points to a second extension header or a transport layer header by a header code of a next header, so as to generate the quality of service control packet;
wherein the first extension header is located previous to an upper layer header and payload;
wherein the second header represents the extension header next to the first extension header, and the header code corresponds to a protocol function of the second extension header.

17. The quality of service control method of claim 16, wherein the first extension header comprises the at least one extension column.

18. The quality of service control method of claim 11, further comprising:
determining the IP version of the packet;
when the IP version of the packet is determined as IPv6, reading a header code of a first extension header of the packet, and determining whether the header code is the same as at least one predetermined code;
when the header code is the same as the at least one predetermined code, determining the packet as the quality of service control packet, and determining whether the priority level parameter exists in the at least one extension column; and
when the priority level parameter is determined as existing in the at least one extension column, scheduling a packet priority of the quality of service control packet according to the priority level parameter, and storing the quality of service control packet in an output register corresponding to the packet priority.

19. The quality of service control method of claim 11, further comprising:
determining the IP version of the packet;
when the IP version of the packet is determined as IPv6, reading a header code of a first extension header of the packet, and determining whether the header code is the same as at least one predetermined code;
when the header code is the same as the at least one predetermined code, determining the packet as the quality of service control packet, and determining whether the retaining parameter exists in the at least one extension column; and
when the retaining parameter is determined as existing in the at least one extension column, calculating a retained time in which the quality of service control packet is stored in a register, reserving the quality of service control packet in the register within the retained time, wherein when a packet request with the same request identification code as the quality of service control packet is received, retransmitting the reserved quality of service control packet to a demand device that sends the packet request.

20. The quality of service control method of claim 11, further comprising:
determining the IP version of the packet;
when the IP version of the packet is determined as IPv6, reading a header code of a first extension header of the packet, and determining whether the header code is the same as at least one predetermined code;
when the header code is the same as the at least one predetermined code, determining the packet as the quality of service control packet, and determining whether the packet rate control parameter exists in the at least one extension column; and
when the packet rate control parameter is determined as existing in the at least one extension column, setting a continuous output time period of the quality of service control packet with the same data session identification code according to the packet rate control parameter.
